(19) United States
(12) Patent Application Publication
(10) Pub. No.: US 2025/0315524 A1
(43) Pub. Date: Oct. 9, 2025

(54) EXPERT SYSTEM FOR DETECTING MALWARE IN BINARIES

(71) Applicant: MICROSOFT TECHNOLOGY LICENSING, LLC, Redmond, WA (US)

(72) Inventors: Jonathan Karl LARSON, Bremerton, WA (US); Dustin Richard FRAZE, Leesburg, VA (US); Michael T. WALKER, Redmond, WA (US); Rodrigo Martins RACANICCI, Araraquara (BR); Audrey Annika DUTCHER, Tempe, AZ (US)

(21) Appl. No.: 18/896,763

(22) Filed: Sep. 25, 2024

Related U.S. Application Data
(60) Provisional application No. 63/631,420, filed on Apr. 8, 2024.

(51) Int. Cl. G06F 21/56

(52) U.S. Cl. CPC G06F 21/56; G06F 2221/034

(57) ABSTRACT

This disclosure describes an expert system that can be used to automatically understand the function of a binary. The expert system includes a large language model (LLM) to determine investigatory steps that are implemented by a suite of tools. One application is malware detection. The expert system uses the tools to gather data and manipulate the binary to gain greater understanding of its function. Data generated during the investigation can be stored and retrieved from a memory representation system. This involves the LLM designing an investigation plan based on both default choices and responses to the data gathered using the tools. The expert system can adjust the plan after each step. Translators use expert knowledge and understanding of tool functions to convert tool outputs into natural language prompts that can be meaningfully understood by the LLM and to convert natural language output by the LLM into calls to the tools.

### PRIORITY APPLICATION

This application claims the benefit of and priority to U.S. Provisional Application No. 63/631,420, filed Apr. 8, 2024, the entire contents of which are incorporated herein by reference.

### BACKGROUND

Most malware is currently identified by comparing a signature of the malware to a database containing known malware signatures. If there is a match, a binary is identified as malware. However, even if there is no match the binary may still be malware. Previously unidentified malware with an unrecognized signature is currently identified by human analysts using reverse engineering tools and their own insight. Many of these tools are artisanal and require expert knowledge to use effectively. Different tools provide different skills and is up to the analyst to select which tools to use and how to use them. Sometimes different tools and even different analysts come to different conclusions regarding the safety of a binary.

The challenge of identifying malware is compounded by the scale at which new software is created. For any given platform (e.g., Windows®, Mac OS®, Android®, etc.) there may be thousands or tens of thousands of new programs made available every day. The makes effective and timely vetting difficult to implement solely with human analysts. Cybersecurity will be improved by automated techniques that can accurately identify new malware at scale. The following disclosure is made with respect to these and other considerations.

### SUMMARY

This disclosure pertains to an expert system for detecting malware in binaries. The system is designed to understand the function of a binary automatically and rapidly. It includes a large language model (LLM) that determines a series of investigatory steps implemented by a suite of tools. The function of a binary may include determining if the binary is malware. The expert system uses the tools to gather data and manipulate the binary to gain a greater understanding of its function. This involves the LLM designing an investigation plan based on both default choices and responses to the data gathered using the tools. The expert system can adjust the plan after each step. Translators use expert knowledge and understanding of tool functions to convert tool outputs into natural language prompts that can be meaningfully understood by the LLM and to convert natural language output by the LLM into calls to the tools.

The method for analyzing a function of a binary includes receiving the binary and parsing it with one or more of a suite of tools (SOT) to create tool outputs. A memory representation system (MRS) is initialized with the tool outputs. A natural language prompt is sent to an LLM by a large language model (LLM) orchestrator (LO). The natural language prompt contains instructions to reason about the tool outputs in the MRS and to determine an investigatory step. The LLM generates instructions to perform the investigatory step, wherein the instruction specifies a tool of the SOT and data stored in the MRS. The tool of the SOT is called to implement the investigatory step. The contents of the MRS are modified with a subsequent tool output received from the tool. These steps are iteratively repeated until a termination condition is reached. The function of the binary is then analyzed by the LLM.

The SOT comprises software reverse engineering tools including at least one of a decompiler, a disassembler, a string deobfuscator, an unpacker, a control flow extractor, or a memory analysis tool. The natural language prompt is generated by fetching the tool outputs from the MRS, translating the tool outputs to natural language text, and combining the natural language text with descriptions of individual tools in the SOT and requirements for using each of those tools. The tool outputs comprise runtime objects. Translating the tool outputs to natural language text uses context provided by expert knowledge regarding the function and use of individual tools in the SOT to generate the natural language text.

Calling a tool of the SOT involves parsing the instructions to perform the investigatory step into structured information comprising the reasoning for using the tool, identification of the tool, and one or more operands for the tool. The structured information is translated to data to generate a call to the tool. Tool data from the MRS is provided to the tool. Translating the natural language to data uses context provided by expert knowledge regarding the function and use of individual tools in the SOT to generate the call to the tool. The call to the tool indicates a runtime object in the MRS or the call can contain a runtime object. The termination condition is the LLM determining the function of the binary, reaching a token limit, or reaching a time limit. Accessing the function of the binary comprises classifying the binary as malware or not.

This expert system also includes error correction to identify and correct errors that may be introduced by the LLM. If the instructions to perform the investigatory step are determined to be invalid, an explanation is generated as to why the instructions are invalid. The explanation is provided as part of a prompt to revise the instructions to the LLM, and revised instructions are received from the LLM.

In some implementations, this expert system for analyzing a function of a binary comprises a processing unit, a memory coupled to the processor and storing computer-executable instructions, a memory representation system (MRS) configured to store tool outputs generated by a suite of tools (SOT), a large language model (LLM) orchestrator (LO) configured to place calls to the SOT, fetch the tool outputs from MRS, and generate a natural language prompt containing instructions to reason about the tool outputs in the MRS and determine an investigatory step to analyze the function of the binary, and an LLM configured to receive the natural language prompt from the LO and generate instructions to perform an investigatory step, wherein the instructions are parsed by the LO and passed to the SOT.

The system further comprises a data to natural language translator (D2NLT) configured to translate the tool outputs from the MRS into natural language text, wherein the D2NLT uses context provided by expert knowledge regarding the function and use of individual tools in the SOT to generate the natural language text. The LO, to generate the natural language prompt, is further configured to combine the natural language text with descriptions of individual tools in the SOT and requirements for using those tools. The system further comprises a natural language to data translator (NL2DT) configured to translate the instructions to perform an investigatory step into a call to the SOT, wherein the NL2DT uses context provided by expert knowledge regarding the function and use of individual tools in the SOT to generate the call. The NL2DT is further configured to determine that the instructions to perform the investigatory step are invalid, generate an explanation why the instructions are invalid, the LO is further configured to provide the explanation as part of a prompt to revise the instructions to the LLM, and the LLM is further configured to generate revised instructions based on the prompt to revise. The LO is further configured to provide a pre-determined prompt to the LLM upon a result of the investigatory step meeting a certain condition.

The techniques of this disclosure may also be embodied on computer-readable media comprising instructions that when executed by a processing unit cause a computing device to perform operations comprising receiving a binary, parsing the binary with one or more of a suite of tools (SOT) to create tool outputs, initializing a memory representation system (MRS) with the tool outputs, sending a natural language prompt to an LLM, the natural language prompt containing instructions to reason about the tool outputs in the MRS and to determine an investigatory step, generating instructions to perform the investigatory step, wherein the instruction specifies a tool of the SOT and data stored in the MRS, calling the tool of the SOT to implement the investigatory step, modifying contents of the MRS with a subsequent tool output received from the tool, iteratively repeating these steps until a termination condition is reached, and analyzing a function of the binary by the LLM. The instructions further cause the computing device to perform operations comprising generating, by the LLM, a textual explanation of the function of the binary. The instructions further cause the computing device to perform operations comprising classifying the binary as malware, generating a signature of the binary, and submitting the signature to a malware tracking database.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRA WINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

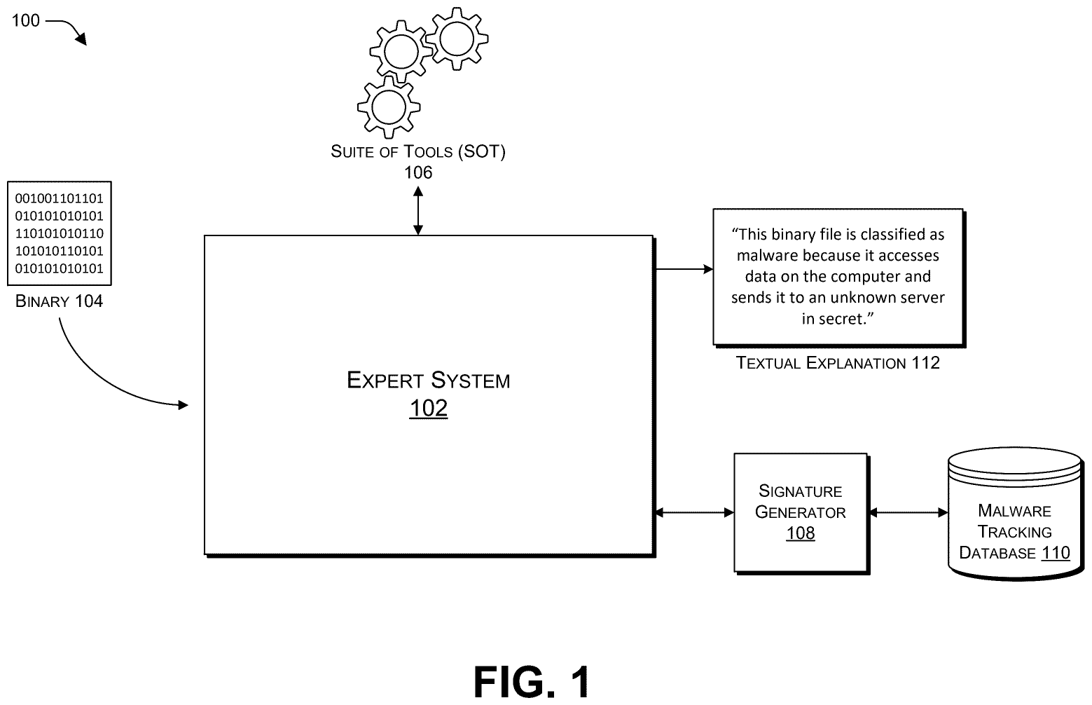

FIG. 1 is a diagram illustrating an expert system for analyzing the function of a binary.

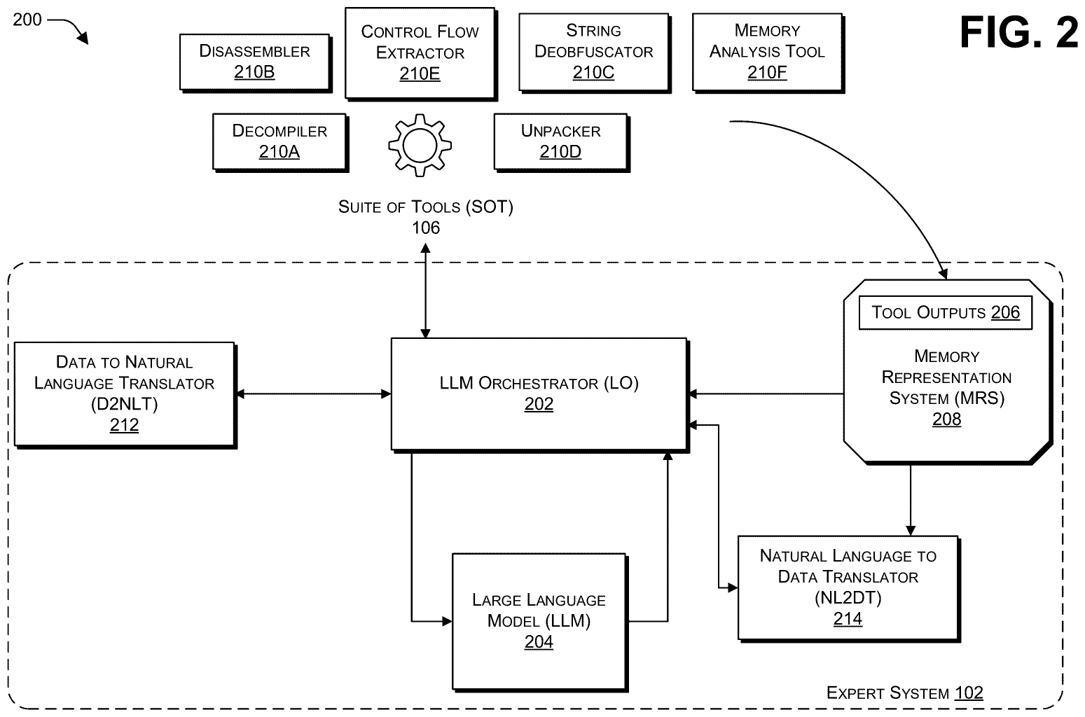

FIG. 2 is a diagram illustrating an architecture of the expert system.

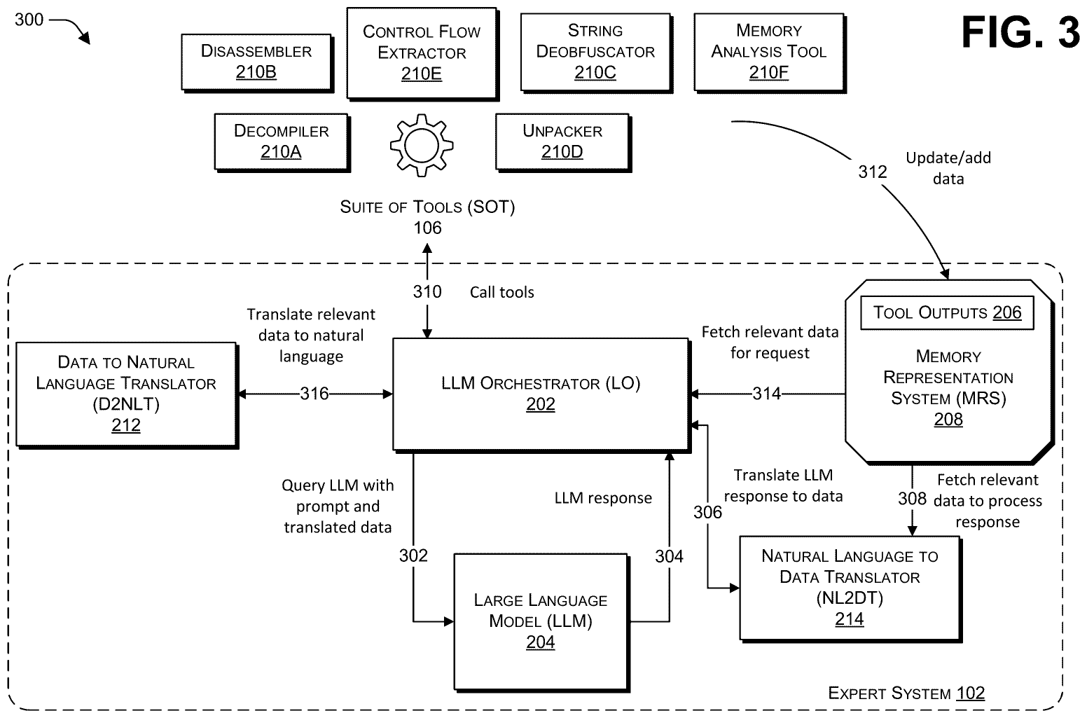

FIG. 3 is a diagram illustrating details of communications between the LLM and other components of the expert system.

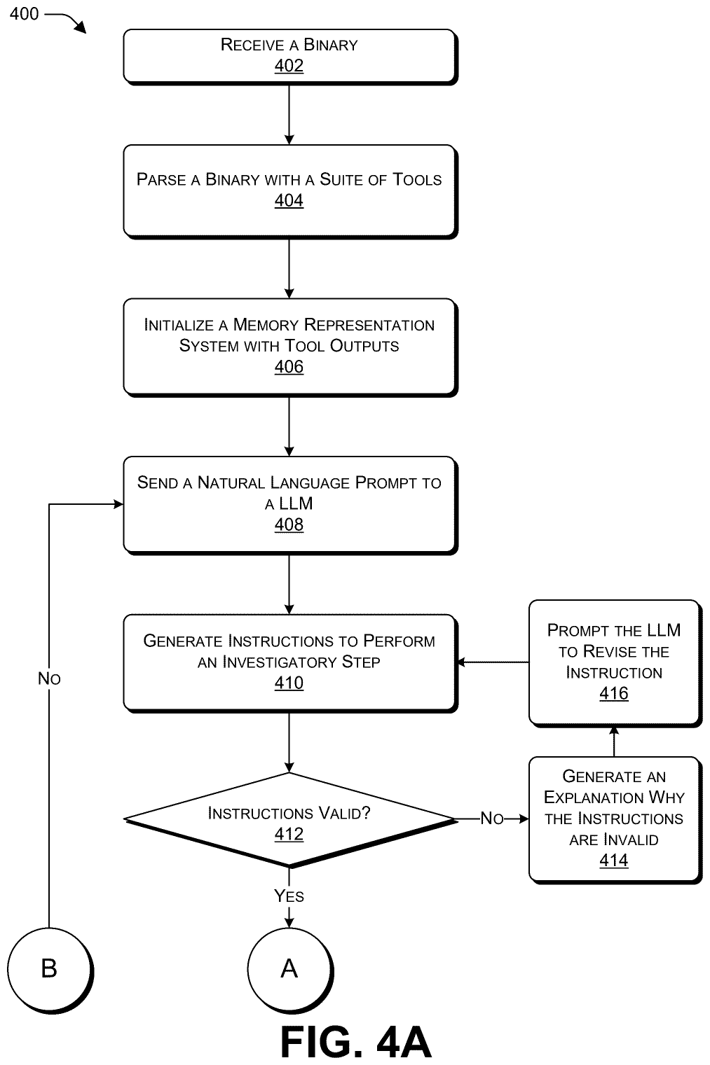

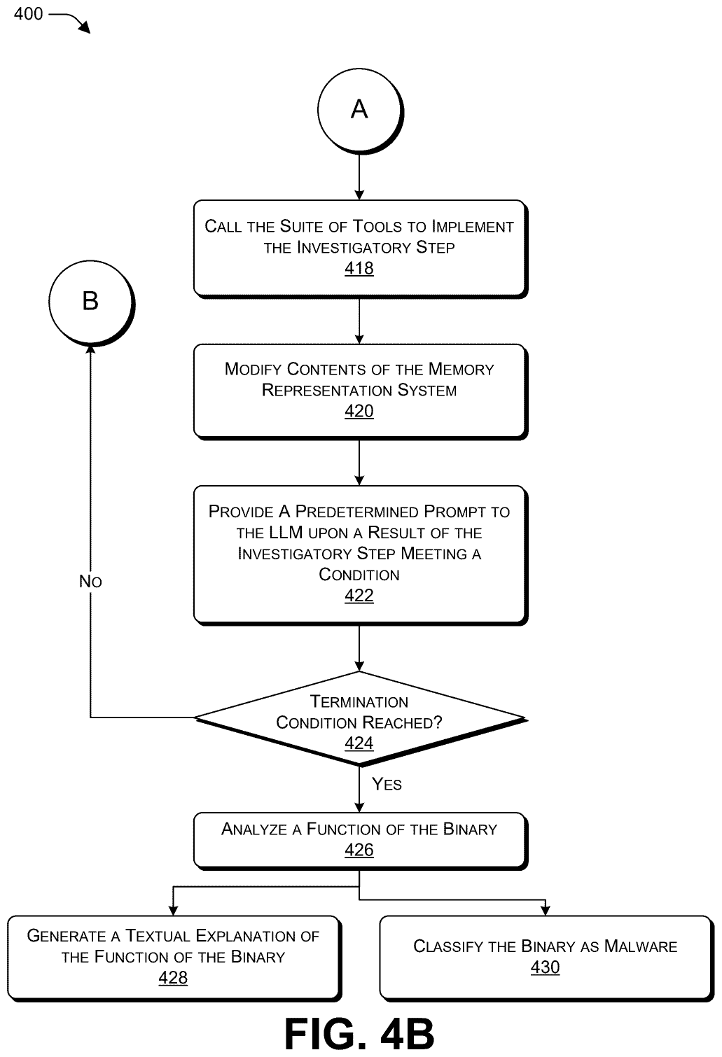

FIGS. 4A and 4B are a flow diagram showing an illustrative process for analyzing the function of a binary.

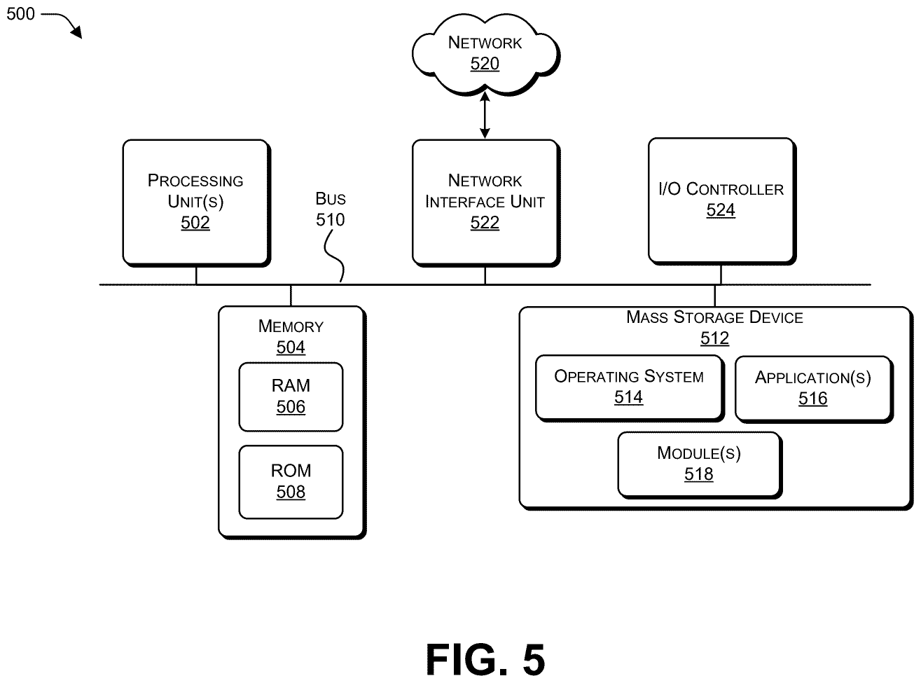

FIG. 5 is a computer architecture diagram illustrating an illustrative computer hardware and software architecture for a computing system capable of implementing aspects of the techniques and technologies presented herein.

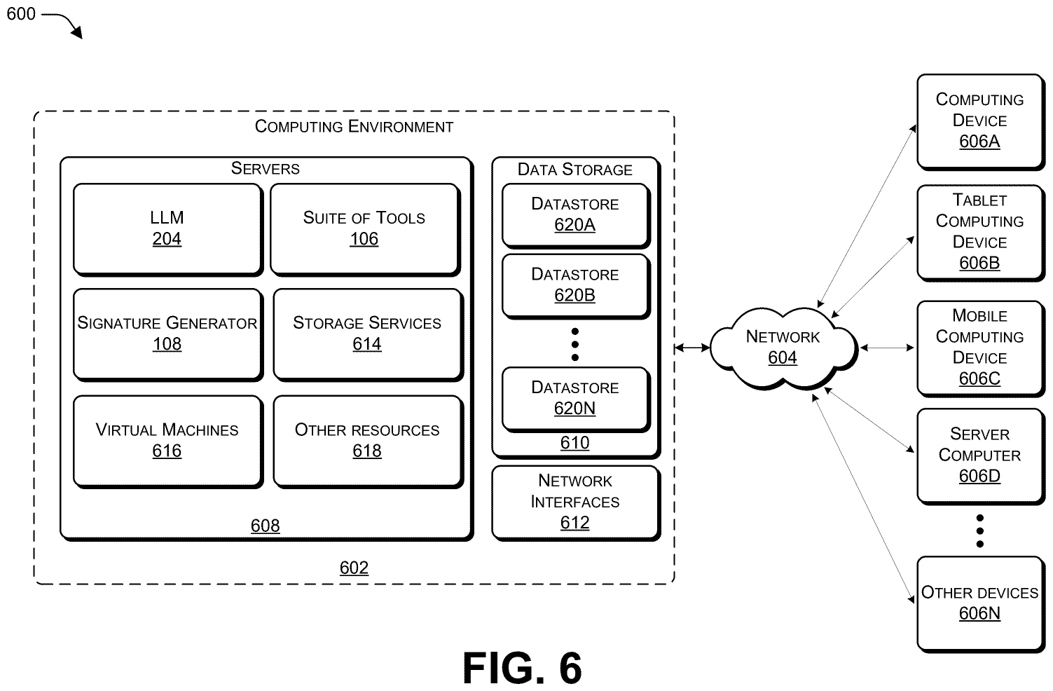

FIG. 6 is a diagram illustrating a distributed computing environment capable of implementing aspects of the techniques and technologies presented herein.

### DETAILED DESCRIPTION

A binary refers to a compiled file that stores data in a non-human-readable format (0s and 1s) unlike source code, which is written in programming languages for humans to understand. There are many reasons for seeking to understand the function of a binary. One important reason is to determine if the binary has functionality which could be malicious. This is impossible do without the use of specialized tools to reverse engineer the binary to understand its function. While malware of any sort is problematic, it is particularly dangerous if drivers contain malware because drivers generally have more access privileges and control over a computing system than other types of software. Driver supply chains often involve many different companies and entities working together to provide drivers for various hardware and software. If a bad actor is able to access the supply chain at any point it could potentially hide malware within a driver. The techniques of this disclosure use automated reverse engineering to detect malware in drivers and evict hidden malware from a driver supply chain.

The expert system of this disclosure uses an LLM to design an investigation and evaluate data generated by cyber analysis tools to check whether, without access to the original source code, a binary contains malicious code or other harmful content. This expert system unifies tools for analyzing binaries with advances in LLMs and novel LLM orchestration to create a reverse engineering capability that is stronger than its component parts. This system can collect and analyze information about the binary and conduct tests to explore hypotheses, in order to determine the intent of the code and answer specific questions about the binary.

In normal practice today, a cyber analyst has a suite of tools that provide such capabilities as decompiling a binary file, searching for obscured universal resource locators (URLs), looking up the URLs in a database of known dangerous URLs, and even executing code in a safe sandbox while observing its behavior. This expert system of this disclosure can access the same tools and create its own plans to interrogate a binary for malware. The LLM is used to orchestrate the actions of the suite of tools and can reason about the results gained from invoking the tools. The LLM also dynamically adjusts its actions as it learns more from each step. Data generated by the tools is stored in a memory that is accessed by the LLM but that does not directly store LLM output. This allows an understanding of the binary to be developed under the direction of the LLM while also preventing propagation of any hallucinations generated by the LLM. Additional details of this expert system are provided in the following disclosure.

FIG. 1 illustrates an architecture 100 in which an expert system 102 analyzes the function of a binary 104. The expert system 102 uses a suite of tools (SOT) 106 in an automated way to understand the function of the binary 104 which can include, but is not limited to, determining if the binary 104 contains malware. At the start, the expert system 102 automatically disassembles the binary 104 to analyze and understand its functions. The general operations to understand the capability of a binary can be applied to any binary for any purpose not only for detecting malware. There are many possible ways to trigger the expert system 102 to start its analysis of a binary 104. This analysis may be initiated by a user selecting a binary 104 and providing it to the expert system 102. The analysis may also be started in an automated way by the expert system 102 beginning without being explicitly instructed by a human user. Operation of the expert system 102 may also be initiated every time a binary 104 is downloaded. The expert system 102 may be designed so that it automatically initiates analysis of all binaries 104 found in a certain location such as a folder in a computer file system.

In some implementations, the expert system 102 may first look to see if the binary 104 has a signature that matches any other known malware. This initial signature matching step will generally require much less computational power and memory than performing a more thorough analysis with the suite of tools 106. To do so, the expert system 102 may use a signature generator 108 to generate a signature of the binary 104. The signature may be a static signature or a behavioral signature. Static signatures look for specific patterns of bytes (0s and 1s) in the file that match known malicious code. Behavior signatures focus on what the binary 104 does by looking for suspicious activities. Multiple techniques for generating signatures from binaries 104 are known to those of ordinary skill in the art and any suitable technique, such as hashing, may be used. The signature is then compared with signatures in a malware tracking database 110 to look for a match. If a match is found, the expert system 102 identifies the binary 104 as malware without performing the other techniques provided in this disclosure. However, signature matching will not identify all malware including novel malware (e.g., zero day) and malware that effectively hides malicious behavior. The techniques provided in this disclosure can be used by the expert system 102 to identify such malware.

The expert system 102 uses the suite of tools 106 to perform a more detailed analysis of the binary 104. The specifics of this analysis are described in more detail below. Once the expert system 102 has finished analyzing the binary 104, it may generate a textual explanation 112 for human consumption. The textual explanation 112 can provide a summary of the expert system's 102 analysis of the binary 104. This textual explanation 112 may identify functions and behaviors of the binary 104 including classifying the binary 104 as a particular type of software (e.g., driver, calculator, email client, etc.). One possible use for the expert system 102 is identifying the binary 104 as malware, or not, and this can include an explanation why. In some implementations, the textual explanation 112 may describe characteristics or behaviors in the binary 104 and explain why they are interpreted as malicious or not. An LLM component of the expert system 102 may generate the text of the textual explanation 112. In some implementations, the textual explanation 112 may be defined as text generated by an LLM that provides a characterization of the binary 104 and explains a basis for reaching that characterization. The textual explanation 112 is one possible output generated by the expert system 102. Human users may then take further action regarding the binary 104 based on the textual explanation 112.

Additionally or alternatively, the expert system 102 may also take independent action regarding the binary 104. These actions could be any of the types of actions taken by conventional antivirus software such as quarantining or deleting the binary 104. The expert system 102 may also raise an alert if malware is identified and take steps to protect against the malware. An alert is different from the textual explanation 112 because it will generally be a short statement (e.g., “malware detected”) and does not include an explanation of the basis for the conclusion.

Another action that can be taken by the expert system 102 upon detecting malware is to use the signature generator 108 to generate a signature of the binary 104 and place that signature in the malware tracking database 110. The malware tracking database 110 may then be used by antivirus software to perform signature-based recognition of the binary 104 as malware. These steps enable the expert system 102 to autonomously detect and report malware. Thus, the knowledge gained by the expert system 102 when it detects previously unidentified malware can benefit other systems and users without direct access to the expert system 102.

FIG. 2 illustrates an architecture 200 of the expert system 102 introduced in FIG. 1. Components of the expert system 102 are shown inside the dotted line. Although the suite of tools (SOT) 106 is illustrated as outside of the dotted line it may alternatively be conceptualized as part of expert system 102. The expert system uses an LLM orchestrator (LO) 202 to coordinate and manage a LLM 204 and the operation of the suite of tools 106 to analyze the binary 104.

The LLM orchestrator 202 is used to shape the behavior of the LLM 204 and other components of the expert system 102. The LLM orchestrator 202 can provide preprogrammed functionalities. The LLM orchestrator 202 is also configured to place calls to the suite of tools 106 and to fetch tool outputs 206 or other data from a memory representation system (MRS) 208. Thus, the LLM orchestrator 202 functions as an intermediate layer between the LLM 204 and other components of the system. The current state or context of the LLM orchestrator 202 may also be stored in the MRS 208. The state of the LLM orchestrator 202 provides a record of what has happened in an investigation thus far.

The LLM orchestrator 202 may include multiple pre-defined prompts that can be provided to the LLM 204 based on certain conditions being true and if-then logic. These predefined prompts may be changed by a human user of the expert system 102. For example, the LLM orchestrator 202 may provide an initial prompt to the LLM 204 to start its interaction with the suite of tools 106. For example, when analysis of a binary 104 is initiated, the LLM orchestrator 202 may generate a prompt that causes the LLM 204 to begin the analysis by running some or all of the available tools in the suite of tools 106 on the binary 104. Examples of other prompts may be provided by the LLM orchestrator 202 include prompts related to discovering the functionality of a binary 104. For example, the LLM orchestrator 202 could provide the prompt: “What does this binary do?” An example of a prompt specific to discovering malware is: “Is this file malware?” During each investigatory step the LLM orchestrator 202 also generates a natural language prompt containing instructions to reason about the tool outputs 206 in the MRS 208 and determine an investigatory step to analyze the functions of the binary. All the prompting for the LLM 204 is provided autonomously by the expert system 102 without direct human involvement. Thus, this is distinguished from a chat-type interface in which a human user generates prompts for an LLM. In this system, human involvement may include configuring tool descriptions, parameters, and translators.

The LLM 204 may be any type of LLM that is capable of responding to natural language prompts and generating output based on a probabilistic understanding of a training corpus. The LLM 204 may be a “standard” or unmodified version of the LLM trained on the “Internet” or some other large corpus of text. That is, the LLM 204 may be used in the expert system 102 without any modification or training specific to reverse engineering software or identifying malware. Without being limited by theory, it is believed that an LLM trained on a large corpus of text covering various topics already has a sufficient understanding of necessary concepts to understand the function of software and reason about capabilities of the binary 104 including identifying behavior that is malicious.

One nonlimiting example of an LLM 204 that may be used is a generative pre-trained transformer (GPT) such as GPT-4 turbo provided by OpenAI. GPT-4 Turbo is a variant of the GPT-4 large language model, distinguished by its modified architecture and training technique. It features a deeper and wider transformer encoder-decoder structure with a novel “Turbo Attention” mechanism, which replaces traditional attention heads with a combination of dense and sparse attention layers, allowing for more efficient and effective processing of long-range dependencies in text. Specifically, Turbo Attention employs a hierarchical approach, using dense attention for local context and sparse attention for global context, enabling the model to capture both fine-grained and coarse-grained relationships between input tokens. Trained on a massive dataset using denoising autoencoding, GPT-4 Turbo has approximately 1.76 billion parameters. This architecture and training are optimized for text generation.

The LLM 204 interacts with the suite of tools 106 through translators. The expert system 102 decomposes each of the individual tools 210 within the suite of tools 106 into a set of skills and uses a data to natural language translator (D2NLT) 212 to translate data from the suite of tools 106 into natural language that is meaningful to the LLM 204. The D2NLT 212 is configured to translate the tool outputs from the MRS 306 into natural language text using context provided by expert knowledge regarding the function and use of individual tools in the SOT 106 to generate the natural language text. A natural language to data translator (NL2DT) 214 is used for translating outputs from the LLM 204 back into instructions that can be understood by the suite of tools 106. The NL2DT 214 is configured to translate the instructions to perform an investigatory step into a call to the SOT using context provided by expert knowledge regarding the function and use of individual tools in the SOT 106 to generate the call.

The suite of tools 106 contains multiple different tools 210A-F, individually referred to as a tool 210. The particular tools 210 available to the expert system 102 are tools selected by a human designer when building the overall system. Before requesting analysis of a binary, a user may choose which tools 210 are to be included in the suite of tools 106. This choice may be different for each analysis. All the tools 210 in the suite of tools 106 may be, but are not necessarily, related to a common theme or functionality. For example, most or all of the tools 210 may be tools for reverse engineering software. The individual tools 210 may be freely changed by inclusion or removal of tools 210 and by updating existing tools to newer versions. However, during the analysis of a particular binary 104 the suite of tools 106 is generally fixed and does not change.

Reverse engineering tools allow the expert system 102 to interact with the binary 104 to discover the decompiled code. Examples of reverse engineering tools 210 include, but are not limited to, a decompiler 210A, a disassembler 210B, a string deobfuscator 210C, a control flow extractor 210E, an unpacker 210D, and a memory analysis tool 210F.

The decompiler 210A transforms machine code, the low-level binary language of computers, back into a higher-level, human-readable source code. LLMs are now well known for their ability to understand software code. The disassembler 210B translates the low-level binary language of computers into assembly language or a high-level language such as C, providing a low-level, human-readable representation of the program for reverse-engineering, debugging, and security analysis. The disassembler 210B can be used to determine the precise behavior of the binary and is particularly useful if the binary was written with complex or obfuscated code that may confuse the decompiler 210A. The string deobfuscator 210C is a software tool used in reverse engineering that deciphers obfuscated strings back into their original, human-readable format. The presence of obfuscated code in a binary is often an indication that the designer of the software is trying to hide its function. A control flow extractor 210E extracts a graphical representation of all possible paths that might be traversed through a program during its execution, with each node representing a basic block of code. A control flow graph (CFG) captures the relationships between basic blocks of codes with branches to show different paths that could be traversed and allows a user, or LLM, to walk to the logic of a program. A CFG shows which functions in a program depend on other functions. The unpacker 210D deciphers packed or encrypted binaries, restoring them to their original, executable form for further analysis and understanding. Software may be packed to reduce its size for storage or transmission, and to obfuscate its code, making it harder for others to reverse engineer or tamper with it. This is often done to hide malicious code in the case of malware. The suite of tools 106 may also include other tools not listed here. The memory analysis tool 210F performs containerized memory analysis by inspecting and analyzing the memory usage of binaries running within isolated environments, or containers, to safely investigate the behavior of potentially malicious programs.

For example, one possible source of tools 210 for the suite of tools 106 is the Angr integrated reverse engineering framework. Angr is a binary analysis framework that is platform-agnostic. It utilizes a set of Python 3 libraries, which are pre-compiled modules of code that can be imported and used in Python programs, to enable a variety of tasks. These tasks include disassembly, intermediate-representation lifting, program instrumentation, control-flow analysis, data-dependency analysis, value-set analysis, and decompilation. One of its key features is the symbolic execution engine, which allows for automated reasoning about a program's behavior by executing programs symbolically rather than concretely, thus enabling the exploration of multiple execution paths simultaneously. This makes Angr a comprehensive tool for a wide range of binary analysis tasks, extending its capabilities to both static and dynamic symbolic (“concolic”) analysis.

The LLM 204 designs an investigation plan using the skills provided by the suite of tools 106 to understand the function of the binary 104. The investigation plan may be based in part on domain specific information provided either by the LLM orchestrator 202 or by the data to natural language translator (D2NLT) 212. The investigation used to learn the function of a binary 104 is an LLM-authored and LLM-executed sequential plan. However, the steps of the plan are not decided in advance. The investigation may include many tens or hundreds of individual steps. Each step may consist of one iteration of interaction between the LLM 204 and the suite of tools 106. Investigation is a search that includes multiple branched paths, some long and some short, with the goal of ultimately leading to a full understanding of the functionality of the binary 104.

In addition to writing its own investigation plan, LLM 204 can also independently debug the plan. Skills provided by individual ones of the tools 210 may fail to perform as expected. This may be due to a misapplication of the tool 210 by the LLM 204, due to clever design of the malware to thwart the use of such tools, or for any number of other reasons. Because the investigation is executed iteratively, it is possible to recover from tool failure and adapt the investigation to proceed in a different way. The LLM 204 may do this by selecting a different tool or skill that can provide an analogous result. The investigation could also be adapted by modifying the order of analysis or the order in which the tools 210 are applied to the binary 104 or which specific skills of the tools 210 are used. Moreover, if incorrect parameters are specified for a tool 210, that may be detected, and a step of the investigation rerun using valid parameters.

The investigation plan is updated by the LLM 204 at each step. The LLM 204 is prompted by the LLM orchestrator 202, to make the best use of the suite of tools 106. The LLM 204 is able to freely choose which tools 210 to use and how. In every step, the LLM can decide what to do next based on the prompts provided from the LLM orchestrator 202. For example, if the decompiler 210A is unable to decompile some of the code in the binary 104, the LLM 204 may respond by running a different tool 210, such as a string deobfuscator 210C, on the code that could not be decompiled. Similarly, if packed code is detected in the binary 104, the LLM 204 may change the investigation plan to add a step of running an unpacker 210D to identify the function of the code that is packed. If there is no packed code, the LLM 204 may then proceed through the investigation plan without making use of the unpacker 210D. The LLM 204 is not required to use all available tools.

As one part of the process to understand the function of the binary 104, the LLM 204 may convert decompile binary code into semantic statements of function. That is, the LLM 204 identifies the functions of different parts of the code. By analyzing and interpreting the sum of these parts, the LLM 204 can create a description of how the binary 104 functions as a whole. Understanding how the binary 104 functions as a whole may also be based on assembly language or a high-level language such as C generated by the disassembler 210B in conjunction with the higher-level code created by the decompiler 210A.

The functions of individual blocks of codes may be associated with each other in a CFG generated by the control flow extractor 210E. The CFG can be used to identify all functions that use a first function. The CFG is one example of the tool outputs 206 that may be stored in the MRS 208. The LLM 204 attempts to understand the binary 104 by working through each node of the CFG. The CFG may be used to guide the investigation into the function of the binary 104. This operation may be supported by the LLM orchestrator 202 by providing prompts to the LLM 202 that cause it to continue moving through the CFG down to the leaf nodes. The LLM 204 can be empowered to seek full understanding of the function of the binary 104 by investigating, for each identified function, all other functions on which that function depends. By using the suite of tools 106 together, the LLM 204 is able to perform complex chained tooling disassembly of the binary 104 using recovered code abstractions driven by the CFG.

For example, the LLM 204 can use the LLM orchestrator 202 to call on the skills of the string deobfuscator 210C to deobfuscate code and determine that it calls an application programming interface (API) on the web. This understanding of the obfuscated portion of code can be propagated back up the CFG by placing the output from the string deobfuscator 210C in the MRS in a way that modifies the tool outputs 206. The CFG is then used to determine the effects of other functions identified in the binary 104. For example, other functions that feed into the API call may capture data stored on a local computer and in combination may result in data from an infected computer being sent to the web.

The LLM 204 may use its ability to understand and interpret code to help itself better understand the binary 104 by generating descriptive names for variables and functions. This could be implemented, for example, by creating a decompolation of the binary 104 in human-readable language that initially contains arbitrary names for variables such as “A1” and functions such as “sub_12345” The LLM 204 may then update the names of the nodes in a CFG with new names for the variables and functions. This behavior may be initiated by the LLM orchestrator 202 such as by a prompt to rename variables and functions with descriptive names. The LLM 204 uses its understanding of the code and the function of the variable or function to generate a descriptive name. For example, if the “A1” variable represents the sum of other values the name “A1” could be replaced with the name “sum.” The function “sub_12345” if it reads data from an application programming interface could be renamed “readDataFromAPI.” Because “sum” and “readDataFromAPI” have a natural language meanings related to the function of the variable and function, renaming creates a more meaningful prompt when that name is fed back to the LLM 204 during a subsequent step of the investigation. This helps the LLM 204 to further reason about the code. This type of analysis can be repeated iteratively by the LLM 204 updating the names of variables and descriptions of other parts of the code. The increasing “naturalness” of the language used to represent the binary 104 helps the LLM 204 to better understand the function of the binary 104. By re-analyzing a “rewritten” CFG the LLM 204 may be able to gain a new and more accurate understanding of the binary 104. This rewriting or renaming of variables in the CFG is one limited exception to a design that prevents the LLM 204 from directly placing its output into the MRS 208.

The LLM 204 also obtains data from the memory representation system 208. However, the LLM generally does not directly place data into the MRS 208. The LLM orchestrator 202 calls a tool 210 and the tool outputs 206 are placed into the MRS 208. The memory representation system 208 functions as a place for the expert system 102 to store information generated during the analysis of the binary 104. This information includes the tool outputs 206 as well as any other data a tool 210 may add to the MRS 208. A tool 210 may also directly update content in the MRS 208. Analysis performed by the LLM 204 using the suite of tools 106 creates a large amount of information. That information may be needed for later analysis and for inclusion in prompts to the LLM 204. The memory representation system 208 may be thought of as a “parking lot” the expert system 102 uses to store data including but not limited to tool outputs 206. Information in the memory representation system 208 may be used to create a database or knowledge base of information about the binary 104. This information may then be used by the LLM 204 for Retrieval-Augmented Generation (RAG) to generate a response to a prompt. Thus, the LLM 204 may perform RAG with a self-created knowledge base.

The tool outputs 206 from individual ones of the tools 210 are stored in the memory representation system 208. These tool outputs 206 are the data output by the various tools 210 in the form generated by the tool 210. These tool outputs 206 may be assembly language, a high-level language such as C, or source code created from reverse engineering the binary 104. The tool outputs 206 may be runtime objects that are available for the LLM 204 to reference during its analysis. Other examples of tool outputs 206 include a CFG, memory address locations, hashes, and universal resource locators (URLs). In some implementations, a tool output 206 from a first one of the tools 210 is stored in the memory representation system 208 and then provided as an input to a second one of the tools 210.

The LLM 204 uses its probabilistic model to perform analysis on the binary 104 that can be viewed as self-reasoning. For example, the LLM 204 may be able to use its own judgment to determine if a binary 104 is performing malicious behavior. There is no explicit programming that provides a definition for what is malicious, but the LLM 204 does this through comparing its understanding of the function of the binary 104 to a semantic understanding of “malicious” or “malware” derived from the corpus used to train the LLM 204. This self-reasoning capability is an inherent or emergent property of the LLM 204. The net effect is that the LLM 204 is able to infer in the intent of the binary 104 and subjectively categorize it as malware or not. This self-reasoning allows the LLM 204 to use the available information for making decisions about which of the tools 210 or skills to use in order to complete its investigation. The LLM 204 can do so because the data to natural language translator (D2NLT) 212 provides information to the LLM 202 in a form it can understand—as natural language prompts.

FIG. 3 illustrates an architecture 300 showing details of the LLM orchestrator 202 communicating with the suite of tools 106 and the LLM 204. To understand the function of a binary 104, particularly malware, the LLM 204 may be prompted to investigate secrets. This begins with the LLM orchestrator 202. The LLM orchestrator 202 may send a predetermined prompt to the LLM 204 along communication path 302. As mentioned above, the LLM orchestrator 202 may have a number of predetermined prompts that it provides to the LLM 202 when certain conditions occur. This prompting to discover secrets can cause the LLM 204 to take further action when it cannot understand the meaning of code (e.g., garbled, packed, or obfuscated code) by using the suite of tools 106, in a variety different ways if necessary, in order to gain understanding. For example, the LLM 204 may be able to recognize a command and control string as such and then continue its investigation to determine the function of the command and control string.

To perform its investigation, the LLM 202 generates instructions that are passed along communication path 304 back to the LLM orchestrator 202. This represents the output or response of the LLM 204 to the prompt received along communication path 302. The LO 202 passes the natural language output from the LLM 204 along communication path 306 to the NL2DT 214 to be translated into data that can be used by the LO 202 to create a call to the suite of tools 106. This data is returned along communication path 306 to the LO 202. Some instructions from the LLM 204 may specify the use of data that is stored in the MRS 208 such as previous tool outputs 206 and references to objects previously defined in the MRS 208. In such cases, the NL2DT 214 fetches the relevant data and/or objects to process the response from the MRS over communication path 308. The LO 202 then issues a call to the suite of tools 106 over communication path 310. The call controls operations of the suite of tools 106 such as to call on skills provided a tool 210. There are many techniques known to those of ordinary skill in the art for calling software. These include APIs, web hooks, middleware, orchestration tools, query languages, workflow automation tools, and other types of adapters. All of these, and other similar components, may be used by the LO 202 in a call to the suite of tools 106.

Some of the tools 210 in the suite of tools 106 may be thought of as artisanal tools that require the correct set of parameters and special skills to be used effectively. This expert knowledge for generating the correct calls to a specific tool 210 is captured in the NL2DT 214 and used to translate the instructions provided by the LLM 204 into data that can be submitted by the LO 202 as a call for a tool 210. The LO 202 may combine the translated instructions from the LLM with data from the MRS 208 to create a call that both tells a tool 210 what to do and provides it with the data to act on. In some implementations, the instructions from the LLM may request the use of a specific skill without indicating a tool 210 and the NL2DT 214 is responsible for identifying which tool 210 can best provide that skill. Functioning of the NL2DT 214 is supported by the memory representation system 208 which can provide context in the form of data to the NL2DT 214. The context may enable the NL2DT 214 to process the instructions from the LLM and provide them in a way that is meaningful for the tool 210 receiving the call from the LO 202. One important type of context for reverse engineering software is the CFG. The CFG may be stored in the memory representation system 208. There are numerous ways in which natural language instructions can be translated by the NL2DT 214 into data ultimately a call. The specific results of a translation depends upon the specific tool 210.

Once called, a tool 210 from the suite of tools 106 will provide tool outputs 206 along communication path 312. The tool outputs 206 go first to the memory representation system 208. From the MRS 208, the tool outputs 206 may be fetched by the NL2DT 214 along communication path 308 or fetched by the LO 202 along communication path 314. The tool outputs 206 are generally not in a format that can be understood by the LLM 204. Accordingly, the tool outputs 206 are not directly provided as such to the LLM 204. Rather, tool outputs 206 fetched by the LO 202 are provided along communication path 316 to the D2NLT 212. The D2NLT 212 translates data in the tool outputs 206 into natural language than can be understood by the LLM 204. For example, a tool 210 may generate a raw tool output 206 that is “True” or “False.” A human user of the tool 210 would remember what question was asked of the tool 210 and understand the conditions that would result in the tool 210 would returning “True” or “False.” Thus, the D2NLT 212, using expert knowledge about how to use the tool 210, converts the tool output 206 into natural language text that is meaningful to the LLM 202. In this simple example, the output “False” is expanded to a sentence such as “The binary does not initiate network communications.” While the output “True” is expanded to a sentence such that “The binary is capable of initiating network communications.” The natural language text generated by the D2NLT 212 is returned along communication path 316 to the LO 202. The LO 202 may pass that text unchanged as a prompt to the LLM 204 over communication path 302. Alternatively, the LO 202 may modify the natural language text received from the D2NLT 212 to create the prompt that is sent to the LLM 204. For example, the LO 202 may add context to the natural language text based on data fetched from the MRS 208.

Each prompt received by the LLM 204 will typically tell it more about the functioning of the binary 104. This is considered by the LLM 204 when evaluating its investigation plan and used to determine the next instructions sent out over communication path 304. This creates a dialogue between the LLM 204 and the suite of tools 106, moderated by the LO 202, in which the expert system 102 may be thought of as chatting with itself. Moreover, the tool outputs 206 stored in the MRS 208 can added to when, for example, a skill is used for the first time or previous tool outputs 206 may be updated as understanding of the binary 104 increase. For example, the CFG generated early in the process may be updated and modified multiple times as the investigation proceeds. Additionally, because the MRS 208 functions to store a record of all the output generated by the suite of tools 106 during the investigation from one iteration to the next, previously obtained tool outputs 206 may be used in whole or in part to provide a prompt sent from the LO 202 to the LLM 204 during a subsequent iteration.

The prompts sent from the LO 202 to the LLM 204 may be generated based on context such as the CFG for the binary 104. The interrelationship of functions and the CFG provide context to the LLM 202 and its contents can be used by the LO 202 to improve individual prompts. Other context, such as previously-identified features of the binary 104, stored in the memory representation system 208 may also be used to generate the prompts. The D2NLT 212 is able to access tool outputs 206 fetched by the LO 202 from the memory representation system 208 to obtain additional data if needed to generate a prompt.

One aspect of the NL2DT 214 enables the LLM 204 to interact with objects at the code level. The objects are then used as parameters. This makes it possible for an LLM 204 which cannot understand unmodified binaries to understand the code. Generally, an entire object is not exposed to the LLM 204. Data representing some or all of the object is returned along communication path 306 to the LO 202. The LO 202, then exposes enough of the object so that the LLM 204 is able to reference the object (e.g., refer to the object in its subsequent instructions). The whole object may be stored in the memory representation system 208. Instructions from the LLM 204 may cause the whole object (or some portion) to be provided by the LO 202 to one of the tools 210. Thus, parameters representing objects may be included in prompts generated by the LO 202 while the objects are in the memory representation system 208.

In some implementations, JavaScript Object Notation (JSON) objects may be used to reference data in the memory representation system 208. JSON is a lightweight data-interchange format that is easy for humans to read and write and easy for machines to parse and generate. A JSON object is an unordered collection of key-value pairs, where keys are strings and values can be any valid JSON data type (string, number, object, array, Boolean, or null). This provides a flexible and efficient means for storing structured data. The LLM 204 can operate in “JSON mode,” which means it only returns data structured as JSON objects. Prompts generated by the LO 202 may be used to place the LLM 204 in JSON mode. The LLM 204 may invoke skills of the suite of tools 106 by generating instructions 306 that are JSON objects. Structuring the prompts 308 and the instructions 306 to comply with JSON is one way of facilitating integration of the suite of tools 106 with the LLM 202.

One example interaction between the LLM 204 and the suite of tools 106 is using a skill available from the suite of tools 106 to list all functions of the binary 104. This may be initiated by instructions sent along communication path 304 to “identify all functions in the binary.” The NL2DT 214 translates the instructions to data that can be understood by a tool 210. The LO 202 then receives this translation and issues a call in an appropriate form for the tool 210. The tool 210 identifies the functions in the binary 104 and the result is a list of functions that is stored in the memory representation system 208. The tool output 206 (i.e., the list) is retrieved by the LO from the MRS 208 and formatted as a prompt which is returned to the LLM 204. As described above, the LO 202 may use the D2NLT 212 to translate the data of the tool output 206 into natural language text that can be included in the prompt to the LLM 204. LLM 204 then generates a series of instructions to identify the behavior of each of the functions. This can repeat until all the functions and their respective behaviors are identified.

A further example illustrates one way the D2NLT 212 can convert a tool output 206 into a meaningful prompt for the LLM 204. The output of some reverse engineering tools may be an object represented to the tool 210 as a hexadecimal. However, if the hexadecimal was provided to the LLM 204 it would be meaningless. The role of the D2NLT 212 is to make the hexadecimal meaningful to the LLM 204. This is done by including the expert knowledge of people who understand the tool 210 in the D2NLT 212. The meaningful part of the object, rather than the hexadecimal, is provided to the LLM 204. For example, the function of the object described in natural language may be provided to the LLM 204. This functional description may be generated by an understanding of what was asked of the tool 210, its capabilities, and the range of possible responses that could be received from the tool 210. All of this can be included in the design of the D2NLT 212. Thus, the D2NLT 212 together with the LO 202 is able to convert a tool output 206 into a meaningful prompt for the LLM 204.

### Illustrative Methods

FIGS. 4A and 4B illustrate aspects of a process 400 for analyzing the function of a binary. The process 400 may be implemented with any of the architectures shown in FIGS. 1-3.

The process 400 begins at operation 402 when a binary is received. The binary may be received by an expert system in many ways including being manually loaded by a human user as well as being automatically received.

At operation 404, the binary is parsed with one or more of a suite of tools to create tool outputs. The suite of tools may comprise software reverse engineering tools including at least one of a decompiler, a disassembler, a string deobfuscator, an unpacker, a control flow extractor, or a memory analysis tool. In some implementations, there may be an initial protocol that is run using some or all of a suite of tools to analyze the binary. The initial protocol may be initiated by a predetermined prompt. For example, a predetermined prompt that could be used to start analysis of the binary to detect malware would be a prompt such as:
You are analyzing a windows kernel driver. You can use a number of functions to analyze the binary before producing a result. Please analyze it for signs of malicious behavior and provide a detailed summary of what kind of malice this driver contains (if any). Please analyze as many functions as possible and summarize the behavior in depth.

The initial protocol is provided to start the analysis of the binary and is not based on any response from the LLM. The initial protocol may prompt the LLM to use all tools in the suite of tools to analyze the binary. The initial protocol may prompt the LLM to run selected tools in a particular order on the binary.

At operation 406, a memory representation system (MRS) is initialized with the tool outputs. That is, data and other outputs generated by the suite of tools is stored in the MRS. The tool outputs may be stored as objects such as runtime objects in the MRS making it possible for the LLM or other components of the system to access the tool outputs by referring to the objects.

At operation 408, a natural language prompt is sent to the LLM. This natural image prompt may be sent by the LLM orchestrator to the LLM. The natural language prompt contains instructions to reason about the tool outputs in the MRS and to determine an investigatory step. Although the prompt is generated by a component of the system, sending the prompt to the LLM is analogous to how a user provides a prompt to an LLM in a chat interface. The natural language prompt may be structured such as, for example, as a JSON prompt. The natural language prompt is processed by the LLM.

In some implementations, natural language prompt is generated by fetching any object defined at the MRS including, but not limited to, tool outputs. Once fetched, the object including tool outputs are translated to natural language text and the natural language text is combined with descriptions of individual tools in the suite of tools and the requirements for using each of those tools. Translation of the tool outputs to natural language may be performed by the data to natural language translator (D2NLT). The data to natural language translator converts the tool outputs into natural language text. Thus, this translator “translates” outputs from the tools that are not meaningful to the LLM into text that is meaningful to the LLM. The data to natural language translator layer uses context provided by expert knowledge regarding the function and use of individual tools in the suite of tools to generate the natural language text. The expert knowledge is encoded in the way that the data to natural language translator performs the translations from tool outputs to natural language text. Translation by the data to natural language translator may also use object references defined at the MRS. In some implementations, the data to natural language translator in conjunction with the LLM orchestrator exposes objects generated by the suite of tools at the code level as parameters to the LLM.

At operation 410, the LLM generates instructions to perform an investigatory step. The instructions may specify a tool of the suite of tools and data stored in the MRS. These instructions are generated in response to the natural language prompt sent to the LLM at operation 408. The instructions may also be structured in JSON or another format. The probabilistic determinations of the LLM are used to generate the instructions as with any other response from an LLM to a prompt. The investigatory step is one step in an investigation created and run by the LLM to determine the function of the binary. The tool outputs stored in the MRS are used for RAG. For some responses, the LLM may perform RAG using data in the MRS as a database to generate a response. Responses may also be generated based on the text in a prompt without using RAG. Because the instruction can specify use of data stored in the MRS, tool output from a first tool stored in the MRS may be provided to a second tool of the suite of tools.

At operation 412, it is determined if the instructions to perform the investigatory step are invalid or valid. The instructions generated by the LLM may include hallucinations or be invalid for any number of other reasons. The instructions are used to control the operation of tools in the suite of tools and access tool outputs stored in the MRS. Thus, instructions which request use of tools that are not available or functionality that is not provided by any of the suite of tools are invalid. Additionally, instructions that specify an available tool but request to use it for a function that tool cannot provide are also invalid. Instructions could also be invalid for missing a parameter needed by a tool, using an incorrect operand, or referencing a runtime object that is not in the MRS. In some implementations, the invalidity can be detected by the tool itself which responds with a meaningful message that can be used by the LLM to recover.

At operation 414, if the instructions are invalid, a correction loop begins. A component of the system such as the natural language to data translator (NL2DT) generates an explanation why the instructions are invalid. This explanation is in natural language text and indicates why the instructions cannot be executed. For example, it may explain that a tool included in the instructions is not available or an object is not found in the MRS.

At operation 416, the explanation is provided as part of a prompt to revise the instructions. This prompt to revise the instructions can be passed to the LLM by the LLM Orchestrator. This provides feedback to the LLM about the incorrect usage proposed in the instructions. The correction loop then returns to operation 410 where the LLM generates revised instructions based on the new prompt. These revised instructions are received from the LLM. If the revised instructions are not valid, method 400 will once again proceed to operation 414 and this will repeat until the LLM generates valid instructions.

Once the instructions are valid, method 400 proceeds along the “yes” path to operation 418. At operation 418, a tool of the suite of tools is called to implement the investigatory step. This is done by the instructions sent from the LLM Orchestrator to the tool. Calling the tool may comprise parsing the instructions to perform the investigatory step into structured information. The parsing may be performed by the LLM Orchestrator. The structured information may include reasoning for using the tool, identification of the tool, and one or more operations for the tool. The structure information is translated into data to generate a call to the tool. This translation may be performed by the natural language to data translator (NL2DT). Thus, the instructions in natural language from the LLM following parsing and translation are modified into a format that can be understood by the tool. For example, the call may be an API call specific to the tool being called. The call to the tool may indicate a runtime object in the MRS. This is the point at which the full object, not merely a reference to the object, is obtained from the MRS and provided to one of the tools in the suite of tools. Translation of the natural language to data uses context provided by expert knowledge regarding the function and use of individual tools in the suite of tools. The translation may also use object references defined at the MRS.

At operation 420, the MRS is modified with a subsequent tool output received from the tool. The subsequent tool output is a tool output specific to this investigatory step. All or most of the investigatory steps will generate a tool output. Depending on the specific to output and indeed and currently in the MRS, subsequent tool output may create additional data that is added to the MRS. Alternatively, it may update data already exists in the MRS. Updating includes overwriting data generated in a previous step with the data generated in response the most recent instructions to the tool.

At operation 422, a predetermined prompt is provided to the LLM upon a result of the investigatory step meeting a certain condition. If the certain condition becomes true during the course of the investigation, then the predetermined prompt is provided to the LLM to shape its behavior. However, if such triggering condition does not occur, the entire investigation may be completed without any predetermined prompts mid-investigation. For example, a predetermined prompt(s) may cause the LLM to investigate all the branches of a control flow graph down to the leaf nodes.

At operation 424, it is determined if a termination condition is reached. The termination condition ends the investigation. One termination condition is the LLM determining the function of the binary. For example, classifying the binary as malware or not. Other termination conditions may be based on arbitrary limits for resource usage. For example, the investigation may continue only until a set time limit, number of processor cycles, amount of compute, a token limit, electricity consumption, or cost limit is reached. If the termination condition is a token limit, this represents a limit on the number of tokens that can be used in total by the LLM for receiving prompts and generating instructions. If a termination condition is reached before the LLM has concluded the investigation, the LLM may attempt to answer the initial question based on its work thus far. The answer may be qualified such as by including a confidence level indicating a predicted accuracy of the answer. If the LLM cannot answer the initial question it may explicitly state that it is not able to complete the investigation and cannot answer the question.

If the termination condition is reached, process 400 proceeds along the “yes” path to operation 426. However, if the termination condition is not yet reached, process 400 proceeds along the “no” path and returns to operation 406. Thus, operations 408-422 (or some subset) are iteratively repeated until the termination condition is reached. Each iteration may be referred to as an investigatory step.

At operation 426, the LLM analyzes the function of the binary. This may include identifying the binary as malware or as safe. It may also include an identification of the functions of the binary without necessarily determining if the binary is malware.

At operation 428, the LLM generates a textual explanation of the function of the binary. This may include a characterization of the binary including an indication if the binary is malware or otherwise harmful. The LLM combines documentation lookup skills and summarization power to render informed opinions and present them in the textual explanation. The textual explanation is provided so that a human user can understand what the LLM has learned about the binary.

At operation 430, the binary is classified as malware if the binary is identified as malware. Process 400 may proceed to either or both of operations 428 and 430. Operation 430 may include generating a signature of the binary such as a hash and submitting the signature to a malware tracking database. This may all be done automatically without direct human involvement. The classification and reporting of malware may proceed without generating a textual explanation of the function of the binary. Thus, process 400 may start with a new binary, determine it is malware, and submit its signature to a database so that the binary can be readily recognized by antivirus software. This allows new malware to be identified rapidly at scale.

For ease of understanding, the process discussed in this disclosure is delineated as separate operations represented as independent blocks. However, these separately delineated operations should not be construed as necessarily order dependent in their performance. The order in which the process is described is not intended to be construed as a limitation, and any number of the described process blocks may be combined in any order to implement the process or an alternate process. Moreover, it is also possible that one or more of the provided operations is modified or omitted.

The particular implementation of the technologies disclosed herein is a matter of choice dependent on the performance and other requirements of a computing device. Accordingly, the logical operations described herein are referred to variously as states, operations, structural devices, acts, or modules. These states, operations, structural devices, acts, and modules can be implemented in hardware, software, firmware, in special-purpose digital logic, and any combination thereof. It should be appreciated that more or fewer operations can be performed than shown in the figures and described herein. These operations can also be performed in a different order than those described herein.

It also should be understood that the illustrated methods can end at any time and need not be performed in their entireties. Some or all operations of the methods, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the process 400 can be implemented, at least in part, by modules running the features disclosed herein can be a dynamically linked library (DLL), a statically linked library, functionality produced by an application programing interface (API), a compiled program, an interpreted program, a script, or any other executable set of instructions. Data can be stored in a data structure in one or more memory components. Data can be retrieved from the data structure by addressing links or references to the data structure.

Although the illustration may refer to the components of the figures, it should be appreciated that the operations of the process 400 may also be implemented in other ways. In addition, one or more of the operations of the process 400 may alternatively or additionally be implemented, at least in part, by a chipset working alone or in conjunction with other software modules. In the example described below, one or more modules of a computing system can receive and/or process the data disclosed herein. Any service, circuit, or application suitable for providing the techniques disclosed herein can be used in operations described herein.

### Illustrative Computing Architectures and Environments

FIG. 5 shows additional details of an example computer architecture 500 for a device, such as a computer or a server capable of executing computer instructions (e.g., a module or a program component described herein). The computer architecture 500 illustrated in FIG. 5 includes processing unit(s) 502, a system memory 504, including a random-access memory 506 (RAM) and a read-only memory (ROM) 508, and a system bus 510 that couples the memory 504 to the processing unit(s) 502. In various examples, the processing unit(s) 502 are distributed. Stated another way, one processing unit 502 may be located in a first location (e.g., a rack within a datacenter) while another processing unit 502 is located in a second location separate from the first location. For example, the processing unit(s) 502 can include graphical processing units (GPUs) for executing complex artificial intelligence applications such as LLMs. Moreover, the systems discussed herein can be provided as a distributed computing system such as a cloud service.

Processing unit(s) 502 can represent, for example, a CPU-type processing unit, a GPU-type processing unit, a field-programmable gate array (FPGA), another class of digital signal processor (DSP), or other hardware logic components that may, in some instances, be driven by a CPU. For example, illustrative types of hardware logic components that can be used include Application-Specific Integrated Circuits (ASICs), Application-Specific Standard Products (ASSPs), System-on-a-Chip Systems (SOCs), Complex Programmable Logic Devices (CPLDs), and the like.

A basic input/output system containing the basic routines that help to transfer information between elements within the computer architecture 500, such as during startup, is stored in the ROM 508. The computer architecture 500 further includes a mass storage device 512 on which an operating system 514, application(s) 516, modules 518, and other data described herein is encoded.

The mass storage device 512 is connected to processing system 502 through a mass storage controller connected to the bus 510. The mass storage device 512 and its associated computer-readable media provide non-volatile storage for the computer architecture 500. Although the description of computer-readable media contained herein refers to a mass storage device, the computer-readable media can be any available computer-readable storage media or communication media that can be accessed by the computer architecture 500.

Computer-readable media includes both computer-readable storage media and communication media. Computer-readable storage media includes one or more of volatile memory, nonvolatile memory, and/or other persistent and/or auxiliary computer storage media, removable and non-removable computer storage media implemented in any method or technology for encoding of information such as computer-readable instructions, data structures, program modules, or other data. Thus, computer-readable storage media includes tangible and/or physical forms of media included in a device and/or hardware component that is part of a device or external to a device, including RAM, static RAM (SRAM), dynamic RAM (DRAM), phase change memory (PCM), ROM, erasable programmable ROM (EPROM), electrically EPROM (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer-readable storage media, communication media embodies computer-readable instructions, data structures, program modules, or other data in a modulated data signal, such as a carrier wave, or other transmission mechanism. Computer-readable storage media and communication media are mutually exclusive. Thus, as defined herein, computer-readable storage media does not include communication media. That is, computer-readable storage media does not include media consisting solely of a modulated data signal, a carrier wave, or a propagated signal, per se.

According to various configurations, the computer architecture 500 may operate in a networked environment using logical connections to remote computers through the network 520. The computer architecture 500 may connect to the network 520 through a network interface unit 522 connected to the bus 510. The computer architecture 500 also may include an input/output controller 524 for receiving and processing input from a number of other devices, including a keyboard, mouse, touch, or electronic stylus or pen. Similarly, the input/output controller 524 may provide output to a display screen, a printer, or other type of output device.

The software components described herein may, when loaded into the processing unit(s) 502 and executed, transform the processing unit(s) 502 and the overall computer architecture 500 from a general-purpose computing system into a special-purpose computing system customized to facilitate the functionality presented herein. The processing unit(s) 502 may be constructed from any number of transistors or other discrete circuit elements, which may individually or collectively assume any number of states. More specifically, the processing unit(s) 502 may operate as a finite-state machine, in response to executable instructions contained within the software modules disclosed herein and encoded on the mass storage device 512. These computer-executable instructions may transform the processing system 502 by specifying how the processing unit(s) 502 transition between states, thereby transforming the transistors or other discrete hardware elements constituting the processing unit(s) 502.

FIG. 6 depicts an illustrative distributed computing environment 600 capable of executing the software components described herein. Thus, the distributed computing environment 600 illustrated in FIG. 6 can be utilized to execute any aspects of the software components presented herein. For example, the distributed computing environment 600 can be utilized to execute aspects of the expert system described herein.

Accordingly, the distributed computing environment 600 can include a computing environment 602 operating on, in communication with, or as part of the network 604. The network 604 can include various access networks. One or more client devices 606A-606N (hereinafter referred to collectively and/or generically as “computing devices 606”) can communicate with the computing environment 602 via the network 604. In one illustrated configuration, the computing devices 606 include a computing device 606A such as a laptop computer, a desktop computer, or other computing device; a slate or tablet computing device (“tablet computing device”) 606B; a mobile computing device 606C such as a mobile telephone, a smart phone, or other mobile computing device; a server computer 606D; and/or other devices 606N. It should be understood that any number of computing devices 606 can communicate with the computing environment 602.

In various examples, the computing environment 602 includes servers 608, data storage 610, and one or more network interfaces 612. The servers 608 can host various services, virtual machines, portals, and/or other resources. In the illustrated configuration, the servers 608 host the LLM 202, the suite of tools 106, the signature generator 108, storage services 614, and/or virtual machines 616. As shown in FIG. 6 the servers 608 also can host other services, applications, portals, and/or other resources (“other resources”) 618.

As mentioned above, the computing environment 602 can include the data storage 610. According to various implementations, the functionality of the data storage 610 is provided by one or more databases operating on, or in communication with, the network 604. The functionality of the data storage 610 can also be provided by one or more servers configured to host data for the computing environment 600. The data storage 610 can include, host, or provide one or more real or virtual datastores 620A-620N (hereinafter referred to collectively and/or generically as “datastores 620”). The datastores 620 are configured to host data used or created by the servers 608 and/or other data. That is, the datastores 620 also can host or store malware signatures for example in the malware tracking database 110, web page documents, word documents, presentation documents, data structures, algorithms for execution by a recommendation engine, and/or other data utilized by any application program. Aspects of the datastores 620 may be associated with a service for storing files.

The computing environment 602 can communicate with, or be accessed by, the network interfaces 612. The network interfaces 612 can include various types of network hardware and software for supporting communications between two or more computing devices including the computing devices 606 and the servers 608. It should be appreciated that the network interfaces 612 also may be utilized to connect to other types of networks and/or computer systems.

It should be understood that the distributed computing environment 600 described herein can provide any aspects of the software elements described herein with any number of virtual computing resources and/or other distributed computing functionality that can be configured to execute any aspects of the software components disclosed herein. According to various implementations of the concepts and technologies disclosed herein, the distributed computing environment 600 provides the software functionality described herein as a service to the computing devices. It should be understood that the computing devices 606 can include real or virtual machines including server computers, web servers, personal computers, mobile computing devices, smart phones, and/or other devices. As such, various configurations of the concepts and technologies disclosed herein enable any device configured to access the distributed computing environment 600 to utilize the functionality described herein for providing the techniques disclosed herein, among other aspects.

### Illustrative Embodiments

The following clauses describe multiple possible embodiments for implementing the features described in this disclosure. The various embodiments described herein are not limiting nor is every feature of any given embodiment required to be present in another embodiment. Any two or more of the embodiments may be combined together unless context clearly indicates otherwise. As used herein in this document “or” means and/or. For example, “A or B” means A without B, B without A, or A and B. As used herein, “comprising” means including all listed features and potentially including addition of other features that are not listed. “Consisting essentially of” means including the listed features and those additional features that do not materially affect the basic and novel characteristics of the listed features. “Consisting of” means only the listed features to the exclusion of any feature not listed.

Clause 1. A method for analyzing a function of a binary comprising:
(a) receiving the binary (104);
(b) parsing the binary with one or more of a suite of tools (SOT) (106) to create tool outputs (206);
(c) initializing a memory representation system (MRS) (208) with the tool outputs;
(d) sending a natural language prompt to an LLM (204), the natural language prompt containing instructions to reason about the tool outputs in the MRS and to determine an investigatory step;
(e) generating, by the LLM, instructions to perform the investigatory step, wherein the instructions specify a tool (210) of the SOT and data stored in the MRS;
(f) calling the tool of the SOT to implement the investigatory step;
(g) modifying contents of the MRS with a subsequent tool output received from the tool;
(h) iteratively repeating steps (d) to (g) until a termination condition is reached; and
(i) analyzing the function of the binary by the LLM.

Clause 2. The method of clause 1, wherein the SOT comprises software reverse engineering tools including at least one of a decompiler, a disassembler, a string deobfuscator, an unpacker, a control flow extractor, or a memory analysis tool.

Clause 3. The method of either of clause 1 or 2, wherein the natural language prompt is generated by: fetching the tool outputs from the MRS; translating the tool outputs to natural language text; and combining the natural language text with descriptions of individual tools in the SOT and requirements for using each of those tools.

Clause 4. The method of clause 3, wherein the tool outputs comprise runtime objects.

Clause 5. The method of either of clause 3 or 4, wherein translating the tool outputs to natural language text uses context provided by expert knowledge regarding the function and use of individual tools in the SOT to generate the natural language text.

Clause 6. The method of any of clauses 1-5, wherein calling the tool of the SOT comprises: parsing the instructions to perform the investigatory step into structured information comprising the reasoning for using the tool, identification of the tool, and one or more operands for the tool; translating the structured information to data to generate a call to the tool; and providing tool data from the MRS to the tool.

Clause 7. The method of clause 6, wherein translating the natural language to data uses context provided by expert knowledge regarding the function and use of individual tools in the SOT to generate the call to the tool.

Clause 8. The method of clause 7, wherein the call to the tool indicates a runtime object in the MRS.

Clause 9. The method of any of clauses 1-8, wherein the termination condition is the LLM determining the function of the binary, reaching a token limit, or reaching a time limit.

Clause 10. The method of any of clauses 1-9, wherein accessing the function of the binary comprises classifying the binary as malware or not.

Clause 11. The method of any of clauses 1-10, further comprising: determining that the instructions to perform the investigatory step are invalid; generating an explanation why the instructions are invalid; providing the explanation as part of a prompt to revise the instructions to the LLM; and receiving revised instructions from the LLM.

Clause 12. An expert system for analyzing a function of a binary comprising:
a processing unit (502);
a memory (512) coupled to the processor and storing computer-executable instructions;
a memory representation system (MRS) (208) configured to store tool outputs (206) generated by a suite of tools (SOT) (106);
a large language model (LLM) orchestrator (LO) (202) configured to place calls to the SOT, fetch the tool outputs from MRS, and generate a natural language prompt containing instructions to reason about the tool outputs in the MRS and determine an investigatory step to analyze the function of the binary; and
an LLM (204) configured to receive the natural language prompt from the LO and generate instructions to perform an investigatory step, wherein the instructions are parsed by the LO and passed to the SOT.

Clause 13. The system of clause 12, further comprising a data to natural language translator (D2NLT) configured to translate the tool outputs from the MRS into natural language text, wherein the D2NLT uses context provided by expert knowledge regarding the function and use of individual tools in the SOT to generate the natural language text.

Clause 14. The system of clause 13, wherein the LO, to generate the natural language prompt, is further configured to combine the natural language text with descriptions of individual tools in the SOT and requirements for using those tools.

Clause 15. The system of either clause 12 or 13, further comprising a natural language to data translator (NL2DT) configured to translate the instructions to perform an investigatory step into a call to the SOT, wherein the NL2DT uses context provided by expert knowledge regarding the function and use of individual tools in the SOT to generate the call.

Clause 16. The system of clause 15, wherein the NL2DT is further configured to determine that the instructions to perform the investigatory step are invalid, generate an explanation why the instructions are invalid, the LO is further configured to provided the explanation as part of a prompt to revise the instructions to the LLM, and the LLM is further configured to generate revised instructions based on the prompt to revise.

Clause 17. The system of any one of clauses 12-16, wherein the LO is further configured to provide a pre-determined prompt to the LLM upon a result of the investigatory step meeting a certain condition.

Clause 18. Computer-readable storage media comprising instructions that when executed by a processing unit cause a computing device to perform operations comprising:
(a) receiving a binary (104);
(b) parsing the binary with one or more of a suite of tools (SOT) (106) to create tool outputs (206);
(c) initializing a memory representation system (MRS) (208) with the tool outputs;
(d) sending a natural language prompt to an LLM (204), the natural language prompt containing instructions to reason about the tool outputs in the MRS and to determine an investigatory step;
(e) generating instructions to perform the investigatory step, wherein the instruction specify a tool (210) of the SOT and data stored in the MRS;
(f) calling the tool of the SOT to implement the investigatory step;
(g) modifying contents of the MRS with a subsequent tool output received from the tool;
(h) iteratively repeating steps (d) to (g) until a termination condition is reached; and
(i) analyze a function of the binary by the LLM.

Clause 19. The computer-readable storage media of clause 18, wherein the instructions further cause the computing device to perform operations comprising: generating, by the LLM, a textual explanation of the function of the binary.

Clause 20. The computer-readable storage media of either clause 18 or 19, wherein the instructions further cause the computing device to perform operations comprising: classifying the binary as malware; generating a signature of the binary; and submitting the signature to a malware tracking database.

### Conclusion

While certain example embodiments have been described, including the best mode known to the inventors for carrying out the invention, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. Skilled artisans will know how to employ such variations as appropriate, and the embodiments disclosed herein may be practiced otherwise than specifically described. The accompanying claims and their equivalents are intended to cover such forms or modifications as would fall within the scope and spirit of certain of the inventions disclosed herein.

Conditional language such as, among others, “can,” “could,” “might” or “may,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be either X, Y, or Z, or a combination thereof.

The terms “a,” “an,” “the” and similar referents used in the context of describing the invention (especially in the context of the following claims) are to be construed to cover both the singular and the plural unless otherwise indicated herein or clearly contradicted by context. The terms “based on,” “based upon,” and similar referents are to be construed as meaning “based at least in part” which includes being “based in part” and “based in whole” unless otherwise indicated or clearly contradicted by context. The terms “portion,” “part,” or similar referents are to be construed as meaning at least a portion or part of the whole including up to the entire noun referenced.

In addition, any reference to “first,” “second,” etc. elements within the Summary and/or Detailed Description is not intended to and should not be construed to necessarily correspond to any reference of “first,” “second,” etc. elements of the claims. Rather, any use of “first” and “second” within the Summary, Detailed Description, and/or claims may be used to distinguish between two different instances of the same element (e.g., two different models).

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

1. A method for analyzing a function of a binary comprising:
(a) receiving the binary;
(b) parsing the binary with one or more of a suite of tools (SOT) to create tool outputs;
(c) initializing a memory representation system (MRS) with the tool outputs;
(d) sending a natural language prompt to an LLM, the natural language prompt containing instructions to reason about the tool outputs in the MRS and to determine an investigatory step;
(e) generating, by the LLM, instructions to perform the investigatory step, wherein the instructions specify a tool of the SOT and data stored in the MRS;
(f) calling the tool of the SOT to implement the investigatory step;
(g) modifying contents of the MRS with a subsequent tool output received from the tool;
(h) iteratively repeating steps (d) to (g) until a termination condition is reached; and
(i) analyzing the function of the binary by the LLM.

2. The method of claim 1, wherein the SOT comprises software reverse engineering tools including at least one of a decompiler, a disassembler, a string deobfuscator, an unpacker, a control flow extractor, or a memory analysis tool.

3. The method of claim 1, wherein the natural language prompt is generated by:
fetching the tool outputs from the MRS;
translating the tool outputs to natural language text; and
combining the natural language text with descriptions of individual tools in the SOT and requirements for using each of those tools.

4. The method of claim 3, wherein the tool outputs comprise runtime objects.

5. The method of claim 3, wherein translating the tool outputs to natural language text uses context provided by expert knowledge regarding the function and use of individual tools in the SOT to generate the natural language text.

6. The method of claim 1, wherein calling the tool of the SOT comprises:
parsing the instructions to perform the investigatory step into structured information comprising the reasoning for using the tool, identification of the tool, and one or more operands for the tool;
translating the structured information to data to generate a call to the tool; and
providing tool data from the MRS to the tool.

7. The method of claim 6, wherein translating the natural language to data uses context provided by expert knowledge regarding the function and use of individual tools in the SOT to generate the call to the tool.

8. The method of claim 7, wherein the call to the tool indicates a runtime object in the MRS.

9. The method of claim 1, wherein the termination condition is the LLM determining the function of the binary, reaching a token limit, or reaching a time limit.

10. The method of claim 1, wherein accessing the function of the binary comprises classifying the binary as malware or not.

11. The method of claim 1, further comprising:
determining that the instructions to perform the investigatory step are invalid;
generating an explanation why the instructions are invalid;
providing the explanation as part of a prompt to revise the instructions to the LLM; and
receiving revised instructions from the LLM.

12. An expert system for analyzing a function of a binary comprising:
a processing unit;
a memory coupled to the processor and storing computer-executable instructions;
a memory representation system (MRS) configured to store tool outputs generated by a suite of tools (SOT);
a large language model (LLM) orchestrator (LO) configured to place calls to the SOT, fetch the tool outputs from MRS, and generate a natural language prompt containing instructions to reason about the tool outputs in the MRS and determine an investigatory step to analyze the function of the binary; and
an LLM configured to receive the natural language prompt from the LO and generate instructions to perform an investigatory step, wherein the instructions are parsed by the LO and passed to the SOT.

13. The system of claim 12, further comprising a data to natural language translator (D2NLT) configured to translate the tool outputs from the MRS into natural language text, wherein the D2NLT uses context provided by expert knowledge regarding the function and use of individual tools in the SOT to generate the natural language text.

14. The system of claim 13, wherein the LO, to generate the natural language prompt, is further configured to combine the natural language text with descriptions of individual tools in the SOT and requirements for using those tools.

15. The system of claim 12, further comprising a natural language to data translator (NL2DT) configured to translate the instructions to perform an investigatory step into a call to the SOT, wherein the NL2DT uses context provided by expert knowledge regarding the function and use of individual tools in the SOT to generate the call.

16. The system of claim 15, wherein the NL2DT is further configured to determine that the instructions to perform the investigatory step are invalid, generate an explanation why the instructions are invalid, the LO is further configured to provided the explanation as part of a prompt to revise the instructions to the LLM, and the LLM is further configured to generate revised instructions based on the prompt to revise.

17. The system of claim 12, wherein the LO is further configured to provide a pre-determined prompt to the LLM upon a result of the investigatory step meeting a certain condition.

18. Computer-readable storage media comprising instructions that when executed by a processing unit cause a computing device to perform operations comprising:
(a) receiving a binary;
(b) parsing the binary with one or more of a suite of tools (SOT) to create tool outputs;
(c) initializing a memory representation system (MRS) with the tool outputs;
(d) sending a natural language prompt to an LLM, the natural language prompt containing instructions to reason about the tool outputs in the MRS and to determine an investigatory step;
(e) generating instructions to perform the investigatory step, wherein the instruction specify a tool of the SOT and data stored in the MRS;
(f) calling the tool of the SOT to implement the investigatory step;
(g) modifying contents of the MRS with a subsequent tool output received from the tool;
(h) iteratively repeating steps (d) to (g) until a termination condition is reached; and
(i) analyze a function of the binary by the LLM.

19. The computer-readable storage media of claim 18, wherein the instructions further cause the computing device to perform operations comprising: generating, by the LLM, a textual explanation of the function of the binary.

20. The computer-readable storage media of claim 18, wherein the instructions further cause the computing device to perform operations comprising:
classifying the binary as malware;
generating a signature of the binary; and
submitting the signature to a malware tracking database.
